(19) United States
(12) Patent Application Publication
(10) Pub. No.: US 2012/0184470 A1
(43) Pub. Date: Jul. 19, 2012

(54) Use Of Alk(en)yl Oligoglycosides In Enhanced Oil Recovery Processes

(75) Inventors: Jianhua Mao, Columbus, OH (US); Lei Wang, Shanghai (CN)

(73) Assignee: Cognis IP Management GmbH, Düsseldorf (DE)

(21) Appl. No.: 13/498,997

(22) PCT Filed: Sep. 29, 2009
(86) PCT No.: PCT/EP09/06982

§ 371 Date: Mar. 29, 2012

(51) Int. Cl. C09K 8/68

(52) U.S. Cl. 507/209

(57) ABSTRACT

A method of recovering oil from a subterranean formation is suggested, comprising injection into said formation an aqueous composition comprising a surface-active amount of an alkyl or alkenyl oligoglycoside.

### FIELD OF THE INVENTION

The present invention is related to the area of oil recovery and refers to a method for enhanced oil recovery involving alkyl or alkenyl oligoglycosides as additives.

### BACKGROUND OF THE INVENTION

In the recovery of oil from oil-bearing reservoirs, it usually is possible to recover only minor portions of the original oil in place by the so-called primary recovery methods which utilise only the natural forces present in the reservoir. A variety of supplemental recovery techniques have been employed in order to increase the recovery of oil from subterranean reservoirs. The most widely used supplemental recovery technique is water flooding which involves the injection of water into the reservoir. As the water moves through the reservoir, it acts to displace oil therein to a production system composed of one or more wells through which the oil is recovered.

It has long been recognized that factors such as the interfacial tension between the injected water and the reservoir oil, the relative mobilities of the reservoir oil and injected-water, and the wettability characteristics of the rock surfaces within the reservoir are factors which influence the amount of oil recovered by water flooding. It has been proposed to add surfactants to the flood water in order to lower the oil-water interfacial tension and/or to alter the wettability characteristics of the reservoir rock. Processes which involve the injection of aqueous surfactant solutions are commonly referred to as surfactant water flooding or as low tension water flooding, the latter term having reference to the mechanism involving the reduction of the oilwater interfacial tension. Also, it has been proposed to add rheology modifiers such as polymeric thickening agents to all or part of the injected water in order to increase the viscosity thereof, thus decreasing the mobility ratio between the injected water and oil and improving the sweep efficiency of the water flood.

A problem with stability and effectiveness arises when these surfactants and thickeners are used in environments characterized by temperatures in the range of about 70° C. to about 120°C. and above, high pressures (e.g., up to about 4000 psi), high concentrations of divalent metal ions such as calcium, magnesium, etc. (e.g., up to 3000 ppm or more and in some instances as high as 10,000 or 20,000 ppm), and high salinity (e.g., total dissolves salts (TDS) levels of up to about 200,000 ppm).

Many water flooding applications have employed anionic surfactants. For example, an early paper by W. R. Foster entitled “A Low-Tension Water Flooding Process”, Journal of Petroleum Technology, Vol. 25, February 1973, pp. 205-210, describes a technique involving the injection of an aqueous solution of petroleum sulphonates within designated equivalent weight ranges and under controlled conditions of salinity. The petroleum sulfonate slug is followed by a thickened water slug which contains a thickening agent such as a water-soluble biopolymer. This thickened water slug is then followed by a driving fluid such as field brine which is injected as necessary to carry the process to conclusion.

One problem encountered in water flooding with certain of the anionic surfactants such as the petroleum sulphonates is the lack of stability of these surfactants in so-called “hard water” environments. These surfactants tend to precipitate from solution in the presence of relatively low concentrations of divalent metal ions such as calcium and magnesium ions. For example, divalent metal ion concentrations of about 50-100 ppm and above usually tend to cause precipitation of the petroleum sulphonates.

Non-ionic surfactants, such as polyethoxylated alkyl phenols, polyethoxylated aliphatic alcohols, carboxylic esters, carboxylic amides, and polyoxyethylene fatty acid amides, have a somewhat higher tolerance of polyvalent ions such as calcium or magnesium than do the more commonly utilized anionic surfactants. While it is technically feasible to employ a non-ionic surfactant solution to decrease the interfacial tension between the injected aqueous displacing medium and petroleum contained in some limestone formations, such use is generally not economically feasible for several reasons. Non-ionic surfactants are not as effective on a per mole basis as are the more commonly used anionic surfactants and, additionally, the non-ionic surfactants generally have a higher cost per unit weight than do the anionic surfactants. The polyethoxylated alkyl phenol non-ionic surfactants usually exhibit a reverse solubility relationship with temperature and become insoluble at temperatures of above their cloud points making them ineffective in many oil formations. Non-ionic surfactants that remain soluble at elevated temperatures are generally not effective in reducing interfacial tension. Other types of non-ionic surfactants hydrolyze at temperatures above about 75° C. In addition, common surfactants do not reduce interfacial tension between oil and aqueous phase adequately while exhibiting substantial adsorption on kaolinite clay—which is usually found in the reservoirs—both features which do not allow achieving high percentages of oil recovery

The use of certain combinations of anionic and non-ionic surfactant to combat hard water formations has also been suggested. For example, U.S. Pat. No. 3,811,505 (Texaco) discloses the use of alkyl or alkylaryl sulphonates or phosphates and polyethoxylated alkyl phenols. U.S. Pat. No. 3,811,504 (Texaco) discloses the use of three component mixture including an alkyl or alkylaryl sulphonate, an alkyl polyethoxysulphate and a polyethoxylated alkyl phenol. U.S. Pat. No. 3,811,507 (Texaco) discloses the use of a water-soluble salt of a linear alkyl or alkylaryl sulphonate and a polyethoxylated alkyl sulphate.

Cationic surface-active materials such as quaternary ammonium salts, and derivatives of fatty amines and polyamines, have also been used. However, these compounds have the disadvantage of substantivity or attraction especially towards silicate rock, and they lose their activity by adsorption. For example, U.S. Pat. No. 5,627,144 (Cognis) mentions combinations of alkyl polyglucosides and esterquats as additives for an EOR process, however without providing details.

The use of certain amphoteric surfactants which function as cationics in acid media and become anionic when incorporated in alkaline systems has been suggested. For example, U.S. Pat. No. 3,939,911 (Texaco) discloses a surfactant water flooding process employing a three-component surfactant system. This surfactant system includes an alkyl or alkylaryl sulphonate such as an ammonium dodecyl benzene sulphonate, a phosphate ester sulphonate, and a sulphonated betaine.

While many surfactant water flooding methods have been proposed, there is a substantial, unfulfilled need for surfactants and water flooding methods employing such surfactants that are useful in recovering oil from subterranean formations wherein the surfactants employed are exposed to high temperatures, high salinities, high pressures, and high concentrations of divalent metal ions. At the same time said surfactants should be able to reduce interfacial tension between oil and aqueous phase significantly, while exhibiting low adsorption on kaolinite clay.

### DETAILED DESCRIPTION OF THE INVENTION

The present invention refers to a method of recovering oil from a subterranean formation comprising injection into said formation an aqueous composition comprising a surface-active amount of an alkyl or alkenyl oligoglycoside.

Surprisingly it has been observed that alkyl or alkenyl oligoglucosides show a superior behaviour over the surfactants known for similar EOR processes, since this group of surface active agents show a higher tolerance with respect to temperature, pressure, metal ion content and salinity and also provide a higher wetting power, while showing a lower adsorption to kaolinite clay. For example, the adsorption of a typical anionic surfactant like sodium dodecylbenzene sulfonate is about 10 mg/g of clay, while the number for alkyl oligoglucosides is close to zero.

### Alk(en)yl Oligoglycosides

The alkyl or alkenyl oligoglycosides which can be used in the aqueous compositions according to the invention may be derived from aldoses or ketoses containing 5 or 6 carbon atoms, preferably glucose. Accordingly, the preferred alkyl and/or alkenyl oligoglycosides are alkyl or alkenyl oligoglucosides. These materials are also known generically as “alkyl polyglycosides” (APG). The alk(en)yl oligoglycosides according to the invention correspond to formula (I):

R¹O[G]ₚ (I)

wherein R¹ is an alkyl or alkenyl radical having from 6 to 22 carbon atoms, G is a sugar unit having 5 or 6 carbon atoms and p is a number from 1 to 10. The index p in general formula (I) indicates the degree of oligomerisation (DP degree), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is mostly a broken number. Alk(en)yl oligoglycosides having an average degree of oligomerisation p of 1.1 to 3.0 are preferably used. Alk(en)yl oligoglycosides having a degree of oligomerisation below 1.7 and, more particularly, between 1.2 and 1.4 are preferred from the applicational point of view. The alkyl or alkenyl radical R¹ may be derived from primary alcohols containing 4 to 22 and preferably 8 to 16 carbon atoms. Typical examples are butanol, caproic alcohol, caprylic alcohol, capric alcohol, undecyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and technical mixtures thereof such as are formed, for example, in the hydrogenation of technical fatty acid methyl esters or in the hydrogenation of aldehydes from Roelen's oxo synthesis. Alkyl oligoglucosides based on hydrogenated C₈-C₁₆ coconut oil alcohol having a DP of 1 to 3 are preferred. The alkyl or alkenyl oligoglycoside and preferably the alkyl oligoglucosides can be present in said aqueous composition at a concentration in the range of about 0.01% to about 6%, preferably about 0.1 to about 3% b.w.

### Co-Surfactants

In a preferred embodiment of the present invention said aqueous compositions also comprise surface-active amounts of anionic, non-ionic, amphoteric or zwitterionic surfactants or their mixtures (herein after referred to as “co-surfactants”).

Anionic (co-) Surfactants

Preferably, surfactants of the sulphonate type, alk(en)yl sulphonates, alkoxylated alk(en)yl sulphates, ester sulphonates and/or soaps are used as the anionic surfactants. Suitable surfactants of the sulphonate type are advantageously C₉₋₁₃ alkylbenzene sulphonates, olefin sulphonates, i.e. mixtures of alkene- and hydroxyalkane sulphonates, and disulphonates, as are obtained, for example, by the sulphonation with gaseous sulphur trioxide of C₁₂₋₁₈ monoolefins having a terminal or internal double bond and subsequent alkaline or acidic hydrolysis of the sulphonation products.

Alk(en)yl sulphates. Preferred alk(en)yl sulphates are the alkali and especially the sodium salts of the sulphuric acid half-esters of the C₁₂-C₁₈ fatty alcohols, for example, from coconut butter alcohol, tallow alcohol, lauryl, myristyl, cetyl or stearyl alcohol or from C₈-C₂₀ oxo alcohols and those half-esters of secondary alcohols of these chain lengths. Alk(en)yl sulphates of the cited chain lengths that comprise a synthetic straight chain alkyl group manufactured petrochemically are also preferred. The C₁₂-C₁₆ alkyl sulphates and C₁₂-C₁₅ alkyl sulphates as well as C₁₄-C₁₅ alkyl sulphates and C₁₄-C₁₆ alkyl sulphates are particularly preferred on the grounds of laundry performance. The 2,3-alkyl sulphates, which can be obtained from Shell Oil Company under the trade name DAN™, are also suitable anionic surfactants.

Alk(en)yl ether sulphates. Sulphuric acid mono-esters derived from straight-chained or branched C₇-C₂₁ alcohols ethoxylated with 1 to 6 moles ethylene oxide are also suitable, such as 2-methyl-branched C₉-C₁₁ alcohols with an average of 3.5 mol ethylene oxide (EO) or C₁₂-C₁₈ fatty alcohols with 1 to 4 EO.

Ester sulphonates. The esters of alpha-sulpho fatty acids (ester sulphonates), e.g., the alphasulphonated methyl esters of hydrogenated coco-, palm nut- or tallow acids are likewise suitable.

Ether carboxylic acids. A further class of anionic surfactants is that of the ether carboxylic acids, obtainable by treating fatty alcohol ethoxylates with sodium chloroacetate in the presence of basic catalysts. They have the general formula: RO(CH₂CH₂O)ₚCH₂COOH with R=C₁-C₁₈ and p=0.1 to 20. Ether carboxylic acids are insensitive to water hardness and possess excellent surfactant properties.

Soaps. Soaps, in particular, can be considered as further anionic surfactants. Saturated fatty acid soaps are particularly suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid. Those soap mixtures are particularly preferred that are composed of 50 to 100 wt. % of saturated C₁₂-C₂₄ fatty acid soaps and 0 to 50 wt. % of oleic acid soap.

### Non-Ionic (Co-)Surfactants

Alcohol alkoxylates. The added non-ionic surfactants are preferably alkoxylated and/or propoxylated, particularly primary alcohols having preferably 8 to 18 carbon atoms and an average of 1 to 12 mol ethylene oxide (EO) and/or 1 to 10 mol propylene oxide (PO) per mol alcohol. C₈-C₁₆-Alcohol alkoxylates, advantageously ethoxylated and/or propoxylated C₁₀-C₁₅-alcohol alkoxylates, particularly C₁₂-C₁₄ alcohol alkoxylates, with an ethoxylation degree between 2 and 10, preferably between 3 and 8, and/or a propoxylation degree between 1 and 6, preferably between 1.5 and 5, are particularly preferred. The cited degrees of ethoxylation and propoxylation constitute statistical average values that can be a whole or a fractional number for a specific product. Preferred alcohol ethoxylates and propoxylates have a narrowed homolog distribution (narrow range ethoxylates/propoxylates, NRE/NRP). In addition to these non-ionic surfactants, fatty alcohols with more than 12 EU can also be used. Examples of these are (tallow) fatty alcohols with 14 EO, 16 EO, 20 EO, 25 EO, 30 EO or 40 EO.

Fatty acid ester alkoxylates. Another class of preferred non-ionic surfactants, which are used either as the sole non-ionic surfactant or in combination with other non-ionic surfactants, in particular, together with alkoxylated fatty alcohols and/or alkyl glycosides, are alkoxylated, preferably ethoxylated or ethoxylated and propoxylated fatty acid alkyl esters preferably containing 1 to 4 carbon atoms in the alkyl chain, more particularly the fatty acid methyl esters which are described, for example, in Japanese Patent Application JP-A-58/217598 or which are preferably produced by the process described in International Patent Application WO-A-90/13533. Methyl esters of C₁₂-C₁₈ fatty acids containing an average of 3 to 15 EO, particularly containing an average of 5 to 12 EO, are particularly preferred.

Amine oxides. Non-ionic surfactants of the amine oxide type, for example, N-coco alkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Gemini surfactants. The so-called gemini surfactants can be considered as further surfactants. Generally speaking, such compounds are understood to mean compounds that have two hydrophilic groups and two hydrophobic groups per molecule. As a rule, these groups are separated from one another by a “spacer”. The spacer is usually a hydrocarbon chain that is intended to be long enough such that the hydrophilic groups are a sufficient distance apart to be able to act independently of one another. These types of surfactants are generally characterised by an unusually low critical micelle concentration and the ability to strongly reduce the surface tension of water. In exceptional cases, however, not only dimeric but also trimeric surfactants are meant by the term gemini surfactants.

### Amphoteric or Zwitterionic Co-Surfactants

Betaines. Amphoteric or ampholytic surfactants possess a plurality of functional groups that can ionize in aqueous solution and thereby—depending on the conditions of the medium—lend anionic or cationic character to the compounds (see DIN 53900, July 1972). Close to the isoelectric point (around pH 4), the amphoteric surfactants form inner salts, thus becoming poorly soluble or insoluble in water. Amphoteric surfactants are subdivided into ampholytes and betaines, the latter existing as zwitterions in solution. Ampholytes are amphoteric electrolytes, i.e. compounds that possess both acidic as well as basic hydrophilic groups and therefore behave as acids or as bases depending on the conditions. Especially betaines are known surfactants which are mainly produced by carboxyalkylation, preferably carboxymethylation, of amine compounds. The starting materials are preferably condensed with halocarboxylic acids or salts thereof, more particularly sodium chloroacetate, one mole of salt being formed per mole of betaine. The addition of unsaturated carboxylic acids, such as acrylic acid for example, is also possible. Examples of suitable betaines are the carboxyalkylation products of secondary and, in particular, tertiary amines which correspond to formula R¹R²R³N-(CH₂)_{q}COOX where R¹ is a an alkyl radical having 6 to 22 carbon atoms, R² is hydrogen or an alkyl group containing 1 to 4 carbon atoms, R³ is an alkyl group containing 1 to 4 carbon atoms, q is a number of 1 to 6 and X is an alkali and/or alkaline earth metal or ammonium. Typical examples are the carboxymethylation products of hexylmethylamine, hexyldimethylamine, octyldimethylamine, decyldimethylamine, C_{12/14}-cocoalkyldimethylamine, myristyldimethylamine, cetyldimethylamine, stearyldimethylamine, stearylethylmethylamine, oleyldimethylamine, C_{16/18}-tallowalkyldimethylamine and their technical mixtures, and particularly dodecyl methylamine, dodecyl dimethylamine, dodecyl ethylmethylamine and technical mixtures thereof The commercially available products include Dehyton® AB (Cognis GmbH)

Alkylamido betaines. Other suitable betaines are the carboxyalkylation products of amidoamines corresponding to formula R¹CO—NH—(CH₂)ₚ—N(R³)(R⁴)—(CH₂)_{q}COOX in which R¹CO is an aliphatic acyl radical having 6 to 22 carbon atoms and 0 or 1 to 3 double bonds, R² is hydrogen or an alkyl radical having 1 to 4 carbon atoms, R³ is an alkyl radical having 1 to 4 carbon atoms, p is a number from 1 to 6, q is a number from 1 to 3 and X is an alkali and/or alkaline earth metal or ammonium. Typical examples are reaction products of fatty acids having 6 to 22 carbon atoms, like for example caproic acid, caprylic acid, caprinic acid, lauric acid, myristic acid, palmitic acid, palmoleic acid, stearic acid, isostearic acid, oleic acid, elaidic acid, petroselinic acid, linolic acid linoleic acid, elaeostearic acid, arachidonic acid, gadoleic acid, behenic acid, erucic acid and their technical mixtures with N,N-dimethylaminoethylamine, N,N-dimethylaminopropylamine, N,N-diethylaminoethylamine and N,N-diethylaminopropylamine, which are condensed with sodium chloroacetate. The commercially available products include Dehyton® K and Dehyton® PK (Cognis GmbH) as well as Tego®Betaine (Goldschmidt).

Imidazolines. Other suitable starting materials for the betaines to be used for the purposes of the invention are imidazolines. These substances are also known and may be obtained, for example, by cyclizing condensation of 1 or 2 moles of C₆⁻C₂₂ fatty acids with polyfunctional amines, such as for example aminoethyl ethanolamine (AEEA) or diethylenetriamine. The corresponding carboxyalkylation products are mixtures of different open-chain betaines. Typical examples are condensation products of the above-mentioned fatty acids with AEEA, preferably imidazolines based on lauric acid, which are subsequently betainised with sodium chloroacetate. The commercially available products include Dehyton® G (Cognis GmbH).

The alkyl or alkenyl oligoglycosides on one hand and the co-surfactants on the other may be present in the aqueous composition in ratio by weight of about 10:90 to about 90:10, preferably about 25:75 to about 75:25 and more preferably about 40:60 to about 60:40.

### INDUSTRIAL APPLICATION

Another embodiment of the present invention relates to the use of alkyl or alkenyl oligoglycosides, preferably alkyl oligoglucosides as additives in enhanced oil recovery processes. Finally, the present invention also encompasses the use of aqueous mixtures comprising (a) alkyl or alkenyl oligoglycosides and (b) anionic, non-ionic, amphoteric and/or zwitterionic surfactants as additives in enhanced oil recovery processes.

### Enhanced Oil Recovery (EOR) Processes

A particular advantage of alkyl or alkenyl oligoglycosides when used as surface-active agents in EOR processes is their stability and tolerance. Typical conditions to be found in crude oil formations range up to about 300° C. and pressures up to 4,000 psi. Also TDS of up to 200,000 ppm and concentrations of divalent metal ions of up to 20,000 ppm can be found. These conditions are typically encountered under various circumstances at Prudhoe Bay, the North Sea, the Persian Gulf, the Gulf of Mexico, as well as other major oil fields. In a preferred embodiment the aqueous compositions comprising the surfactants or surfactant mixtures according to the present invention are prepared using sea-water, which makes the process more economic.

The method of the present invention may be carried out utilizing injection and production systems as defined by any suitable arrangement of wells. One well arrangement commonly used in water flooding operations and suitable for use in carrying out the method of the present invention is an integrated five-spot pattern of the type illustrated in U.S. Pat. No. 3,927,716 (Mobil Oil) which is incorporated herein by reference. Other well arrangements used in the art may also be used in carrying out the present invention.

The aqueous composition that is injected in accordance with the inventive method can be referred to as a surfactant slug. In a typical operation, the surfactant slug is injected into the formation through one or more injection wells using standard techniques known in the art, then a buffer slug is injected, and finally an aqueous flooding medium is injected after the buffer slug to drive the oil toward one or more production wells. The surfactant slug typically has a lower viscosity than the buffer slug, and contains an effective amount of surfactant to reduce the oil-water interfacial tension and/or alter the wettability characteristics of the reservoir rock. The surfactant slug can contain a thickener; the concentration of the thickener preferably being in the range of about 0.05% to about 0.2% by weight. The buffer slug contains an effective amount of a thickener to increase the viscosity of the buffer slug to a level above that of the surfactant slug, and thereby decrease the mobility ratio between the injected water and the oil in the formation.

The size of the surfactant slug ranges from about 0.2 to about 3 pore volumes. The concentration of the surfactant or surfactant mixture in the surfactant slug is preferably adjusted in accordance with the size of the slug. Thus, a surfactant slug with a pore volume of about 0.2 preferably has a combined surfactant concentration of about 1 to about 3% by weight. A surfactant slug with a pore volume of about 1 preferably has a surfactant concentration of about 0.1 to about 2% by weight. A surfactant slug with a pore volume of about 2 preferably has a surfactant concentration of about 0.1 to about 1.0% by weight.

The buffer slug can employ any thickening agent that is stable under the anticipated operating conditions. The thickening agent is employed at an effective level to increase the viscosity of the buffer slug to a value in excess of the viscosity of the surfactant slug to provide an enhanced mobility ratio between the buffer slug and the surfactant slug and thereby increase the macroscopic displacement efficiency of the water-flood. Examples of thickeners that are useful under various circumstances include Polysaccharide B-1459 available from Kelco Company under the trade name “Kelzan” or the partially hydrolyzed polyacylamides available from the Dow Chemical Company under the trade name “Pusher” chemicals.

A class of thickeners that is particularly useful includes the homopolysaccharide gum thickeners. These thickeners are typically non-ionic and have a molecular weight that is greater than about one million, preferably in the range of about 1 to about 3.5 million. The polymer structure is preferably a linear chain of anhydroglucose units linked beta (1-3). The homopolysaccharide gum thickeners have a number of significant advantages over many of the conventional water flooding thickeners. First, these thickeners are generally more thermally stable. That is, they undergo only a moderate decrease in viscosity when temperatures increases while most natural and synthetic gums undergo a marked decrease in viscosity with increase in temperature. With these thickeners, the changes in viscosity at low concentrations are relatively small. Second, these thickeners are relatively easy to inject. Close to the injection well, flooding fluids have to flow at relatively fast rates. These thickeners maintain their viscosities almost unchanged after strong mechanical shearing. Third, these thickeners have a relatively high salt tolerance, particularly with respect to divalent and trivalent metal ions. Fourth, the viscosities of the surfactant slugs and buffer slugs of the present invention are relatively unaffected by pH variations in the range of about 3 to about 11.

The buffer slug employed in accordance with the invention preferably has a thickener concentration of about 0.05% to about 0.2% by weight, more preferably about 0.05 to about 0.1% by weight. Preferably, the concentration of thickener in the buffer slug is at least about 0.02% by weight higher than the concentration of thickener in the surfactant slug. The higher concentration of thickener in the buffer slug in relation to concentration of thickener, if any, in the surfactant slug is essential to the effective operation of the method of the present invention to insure proper control of the relative mobilities of the surfactant slug and the buffer slug. The buffer slug preferably has a pore volume in the range of about 0.6 to about 3.

The drive fluid or aqueous flooding medium is injected into the reservoir in sequential order after the surfactant slug and buffer slug. This flooding medium is preferably water and can be any source of water, such as sea water, that is readily available.

### EXAMPLES

### Interfacial Tension (IFT)

### Examples 1 to 9, Comparative Examples C1 to C5

Interfacial tension (IFT) measurements using a spinning drop tensiometer (spinning time: 1 min) were made against a crude oil using various surfactants and surfactant blends. The measurements reported are between the excess oil and the excess brine phases. Aqueous compositions consisting of sea water comprising the surfactant(s) at a concentration of 1.0% b.w. In each test the IFT was measured at 80 ° C. The results are compiled in Table 1. Examples 1 to 9 illustrate the invention; examples Cl to C5 are presented for comparison.

TABLE 1
Interfacial tension [Dyne * cm⁻¹] of surfactants and surfactant mixtures [%]

| | Examples | | | | | | |
|---|---|---|---|---|---|---|---|
| | 1 | 2 | C1 | C2 | C3 | C4 | C5 |
| Octyl oligoglucoside | 100 | — | — | — | — | — | — |
| Lauryl oligoglucoside | — | 100 | — | — | — | — | — |
| Sodium octyl sulphate | — | — | 100 | — | — | — | — |
| Sodium dodecyl benzene | — | — | — | 100 | — | — | — |
| sulphonate | | | | | | | |
| Lauryl alcohol + 10EO | — | — | — | — | 100 | — | — |
| Lauryl amine oxide | — | — | — | — | — | 100 | — |
| Cocamidopropyl betaine | — | — | — | — | — | — | 100 |

Results

| | | | | | | | |
|---|---|---|---|---|---|---|---|
| Interfacial tension | 0.005 | 0.005 | 1.0 | 0.5 | 1.2 | 1.1 | 1.3 |

Interfacial tension [Dyne * cm⁻¹] of surfactants and surfactant mixtures [%]

| | Examples | | | | | | |
|---|---|---|---|---|---|---|---|
| | 3 | 4 | 5 | 6 | 7 | 8 | 9 |
| Octyl oligoglucoside | 75 | 50 | 75 | 50 | 25 | 50 | 50 |
| Sodium octyl sulphate | 25 | 50 | — | — | — | — | — |
| Sodium dodecyl benzene | — | — | 25 | 50 | 75 | — | — |
| sulphonate | | | | | | | |
| Lauryl alcohol + 10EO | — | — | — | — | — | 50 | — |
| Cocamidopropyl betaine | — | — | — | — | — | — | 50 |

Results

| | | | | | | | |
|---|---|---|---|---|---|---|---|
| Interfacial tension | 0.004 | 0.004 | 0.004 | 0.004 | 0.005 | 0.004 | 0.004 |

### Oil Recovery

### Example 10 to 18, Comparative Examples C6 to C10

In order to determine the performance in enhanced oil recovery, various surfactants slugs comprising various surfactants at a concentration of about 1% b.w. were injected into a formation through one or more injection wells using standard techniques known in the art, then a buffer slug was injected, and finally an aqueous flooding medium was injected after the buffer slug to drive the oil toward the production wells. The term “pore volume” (PV) is used herein to mean that volume of the portion of the formation underlying the well pattern employed, as described in greater detail in U.S. Pat. No. 3,927,716 already cited above. The results depending on the pore volume are presented in Table 2. Examples 10 to 18 illustrate the invention; examples C6 to C10 are presented for comparison.

TABLE 2
Oil recovery [%] using various surfactant slugs

| | Examples | | | | | | |
|---|---|---|---|---|---|---|---|
| | 10 | 11 | C6 | C7 | C8 | C9 | C10 |
| Octyl oligoglucoside | 100 | — | — | — | — | — | — |
| Lauryl oligoglucoside | — | 100 | — | — | — | — | — |
| Sodium octyl sulphate | — | — | 100 | — | — | — | — |
| Sodium dodecyl | — | — | — | 100 | — | — | — |
| benzene sulphonate | | | | | | | |
| Lauryl alcohol + 10EO | — | — | — | — | 100 | — | — |
| Lauryl amine oxide | — | — | — | — | — | 100 | — |
| Cocamidopropyl | — | — | — | — | — | — | 100 |
| betaine | | | | | | | |

Results

| | | | | | | | |
|---|---|---|---|---|---|---|---|
| Oil recovery | 41 | 42 | 32 | 36 | 29 | 18 | 20 |
| (PV = 1.0) | | | | | | | |
| Oil recovery | 51 | 50 | 33 | 38 | 31 | 19 | 21 |
| (PV = 1.5) | | | | | | | |
| Oil recovery | 54 | 50 | 35 | 40 | 33 | 20 | 21 |
| (PV = 2.0) | | | | | | | |

Oil recovery [%] using various surfactant slugs

| | Examples | | | | | | |
|---|---|---|---|---|---|---|---|
| | 12 | 13 | 14 | 15 | 16 | 17 | 18 |
| Octyl oligoglucoside | 75 | 50 | 75 | 50 | 25 | 50 | 50 |
| Sodium octyl sulphate | 25 | 50 | — | — | — | — | — |
| Sodium dodecyl | — | — | 25 | 50 | 75 | — | — |
| benzene sulphonate | | | | | | | |
| Lauryl alcohol + 10EO | — | — | — | — | — | 50 | — |
| Cocamidopropyl | — | — | — | — | — | — | 50 |
| betaine | | | | | | | |

Results

| | | | | | | | |
|---|---|---|---|---|---|---|---|
| Oil recovery | 55 | 53 | 55 | 56 | 55 | 50 | 48 |
| (PV = 1.0) | | | | | | | |
| Oil recovery | 57 | 55 | 57 | 57 | 57 | 51 | 50 |
| (PV = 1.5) | | | | | | | |
| Oil recovery | 58 | 57 | 59 | 59 | 59 | 53 | 51 |
| (PV = 2.0) | | | | | | | |

1. A method of recovering oil from a subterranean formation comprising injecting into said formation an aqueous composition comprising a surface-active amount of an alkyl or alkenyl oligoglycoside.

2. The method of claim 1, wherein said alkyl or alkenyl oligoglycosides follow general formula (I)
R¹O[G]ₚ (I)
wherein R¹ is an alkyl or alkenyl radical having from 4 to 22 carbon atoms, G is a sugar unit having 5 or 6 carbon atoms and p is a number from 1 to 10.

3. The method of claim 1 wherein said alkyl or alkenyl oligoglycosides are present in said aqueous composition at a concentration in the range of about 0.01% to about 6% by weight.

4. The method of claim 1, wherein said aqueous compositions also comprise surface-active amounts of co-surfactants selected from the group consisting of anionic, non-ionic, amphoteric or zwitterionic surfactants and their mixtures.

5. The method of claim 4, wherein said anionic surfactants are selected from the group consisting of alk(en)yl sulphonates, alkoxylated alk(en)yl sulphates, ester sulphonates, ethercarboxylic acids, soaps and their mixtures.

6. The method of claim 4, wherein said non-ionic surfactants are selected from the group consisting of alcohol alkoxylates, fatty acid ester alkoxylates, amine oxides, gemini surfactants and their mixtures.

7. The method of claim 4, wherein said amphoteric or zwitterionic surfactants are selected from the group consisting of betaines, alkylamido betaines, imidazolines and their mixtures.

8. The method of claim 4, wherein said alkyl or alkenyl oligoglycosides and said co-surfactants are present in said aqueous compositions in a ratio by weight of about 10:90 to about 90:10.

9. The method of claim 1, wherein the average temperature of the oil in said formation is in the range of up to about 300° C.

10. The method of claim 1, wherein the water in said aqueous composition has a TDS of up to about 200,000 ppm.

11. The method of claim 1, wherein said aqueous composition has a divalent metal ion concentration of up to about 20,000 ppm.

12. The method of claim 1, wherein the pressure within said formation ranges up to about 4000 psi.

13. The method of claim 1, wherein the water in said aqueous composition comprises sea water.

14. A method of enhancing oil recovery comprising using an alkyl or alkenyl oligoglycoside as an additive in an enhanced oil recovery process.

15. A method of enhancing oil recovery comprising using an aqueous mixture comprising (a) an alkyl or alkenyl oligoglycoside and (b) an anionic, non-ionic, amphoteric and/or zwitterionic surfactant as an additive in an enhanced oil recovery process.

16. The method of claim 2, wherein said alkyl or alkenyl oligoglycosides have an average p value between 1.1 and 3.

17. The method of claim 1, wherein said alkyl oligoglycoside comprises octyl oligoglucoside or lauryl oligoglucoside.

18. The method of claim 14, wherein said alkyl or alkenyl oligoglycosides follow general formula (I)
R¹O[G]ₚ (I)
wherein R¹ is an alkyl or alkenyl radical having from 4 to 22 carbon atoms, G is a sugar unit having 5 or 6 carbon atoms and p is a number from 1 to 10.

19. The method of claim 15, wherein said alkyl or alkenyl oligoglycosides follow general formula (I)
R¹O[G]ₚ (I)
wherein R¹ is an alkyl or alkenyl radical having from 4 to 22 carbon atoms, G is a sugar unit having 5 or 6 carbon atoms and p is a number from 1 to 10.

20. The method of claim 15, wherein said alkyl or alkenyl oligoglycosides and said co-surfactants are present in said aqueous compositions in a ratio by weight of about 10:90 to about 90:10.
